(19) United States
(12) Patent Application Publication
(10) Pub. No.: US 2004/0240415 A1
(43) Pub. Date: Dec. 2, 2004

(54) Base station-centric method for managing bandwidth and QoS in error-prone system

(76) Inventor: Richard Lane, San Diego, CA (US)

Correspondence Address: Qualcomm Incorporated, Patents Department, 5775 Morehouse Drive, San Diego, CA, 92121-1714, US

(21) Appl. No.: 10/453,083

(22) Filed: Jun. 2, 2003

(51) Int. Cl. H04B 7/216

(52) U.S. Cl. 370/335; 370/342; 370/252

(57) ABSTRACT

A wireless transmission system for multimedia information having plural layers includes a base station (BTS) that can select which layers to transmit based on reported channel conditions, mobile location, and/or forward error correction (FEC) used for a particular layer. A respective FEC rate or transmission power can be dynamically established for each layer upon request from at least one mobile station dependent on available bandwidth and/or current channel usage and/or priorities.

### FIELD OF THE INVENTION

The present invention relates generally to multimedia transmission.

### BACKGROUND

Multimedia such as video and audio can be transmitted over a number of paths, including cable, the Internet, cellular and broadcast. For instance, satellite or terrestrial broadcast stations or cellular systems can be used to transmit multimedia to mobile computing devices such as mobile telephones. The multimedia data can be formatted in accordance with Moving Pictures Expert Group (MPEG) standards such as MPEG-1, MPEG-2 (also used for DVD format), MPEG-4 and other block based transform codecs. Essentially, for individual video frames these multimedia standards use Joint Photographic Experts Group (JPEG) compression. In JPEG, the image of a single frame is typically divided into small blocks of pixels (usually 8×8 and/or 16×16 pixel blocks) that are encoded using a discrete cosine transform (DCT) function to transform the spatial intensity values represented by the pixels to spatial frequency values, roughly arranged, in a block, from lowest frequency to highest. Then, the DCT values are quantized, i.e., the information is reduced by grouping it into chunks by, e.g., dividing every value by 10 and rounding off to the nearest integer. Since the DCT function includes a progressive weighting that puts bigger numbers near the top left corner of a block and smaller numbers near the lower right corner, a special zigzag ordering of values can be applied that facilitates further compression by run-length coding (essentially, storing a count of the number of, e.g., zero values that appear consecutively, instead of storing all the zero values). If desired, the resulting numbers may be used to look up symbols from a table developed using Huffman coding to create shorter symbols for the most common numbers, an operation commonly referred to as “variable length coding”. Other variable length coding schemes can be used as well, including Arithmetic coding. Motion pictures add a temporal dimension to the spatial dimension of single pictures. MPEG is essentially a compression technique that uses motion estimation to further compress a video stream. Other non-block-based encoding schemes such as wavelets, matching pursuits, etc can be used. Other forms of multimedia include audio, graphics, etc.

Internet Protocol (IP)-based principles such as point-to-point protocol (PPP) framing of IP packets can be used to communicate multimedia data, including MPEG data. PPP can be used not only for communicating IP packets over wired portions of the Internet, but also to communicate data over wireless transmission paths to user computers that employ wireless communication principles such as but not limited to code division multiple access (CDMA) technology, GSM, wideband CDMA (WCDMA or UMTS), OFDM and other wireless technologies.

Typically, multimedia data is voluminous, which means that significant transmission path bandwidth, unfortunately a finite resource, must be used. This is particularly the case for high fidelity multimedia, e.g., high resolution video. That is, the higher the quality of service (QoS) provided, the more bandwidth must be used.

As recognized by the present invention, several multimedia streams can be pooled together in a single channel. The channel might have a constant overall bandwidth in terms of bit rate, i.e., the number of bits that can be transmitted in the channel per unit time cannot exceed the “bandwidth” of the channel. Typically, each stream in the channel will be accorded a fixed fraction of the bandwidth. Accordingly, the bit rate for each multimedia stream typically is fixed.

A “base layer” is an MPEG-related term that may be defined as the most important part of the multimedia bit stream which, if successfully received, decoded, and presented to the user, would result in a baseline level of video, audio, or other multimedia stream acceptable to the user. On the other hand, an “enhancement layer” would, when combined with the base layer, enhance or improve the quality, resolution, frequency, signal-to-noise ratio, etc. of the multimedia stream when presented to the user, compared to that of the base layer alone.

With the above discussion in mind, it will be appreciated that in wireless transmission of multimedia, two goals—efficient bandwidth use, and highest QoS—compete with each other. This is particularly true when one considers that wireless channels are more “lossy” (they experience more lost data) than wired channels. To guarantee some higher levels of QoS, extra bandwidth might be required for retransmission of lost data. The alternative is to accept lost data frames and, hence, reduced QoS. These problems become more severe the further a receiver is from a base station, and with high use channels. As an alternative to retransmission, a software application in a receiver experiencing reduced QoS can attempt to execute advanced error correction schemes, but this in turn drains the battery of the receiver and may still result in unacceptably low QoS. Having recognized these problems, the below-described solutions to one or more of them are provided herein.

### SUMMARY OF THE INVENTION

In a wireless transmission system for multimedia that has at least a base layer and one enhancement layer, the base station (BTS) selects which layers of multimedia streams to transmit based on at least one of: channel conditions, mobile station location, mobile station limitations, user priority, content priority, billing plans, and the forward error correction (FEC) used for a particular layer. The time that a mobile station receiver is on during transmission and reception of multimedia signals can thus be minimized to reduce power consumption on the mobile station. In addition, the cellular service provider can have better control over bandwidth allocation, bandwidth consumption and BTS load balancing. The BTS can employ different FEC rates and/or different power levels upon request from the mobile devices and dependent on available bandwidth and current channel usage and priorities.

By allowing for changing FEC rates and/or power levels for each layer, and by not transmitting unusable layers, delivery for the most important layers can be guaranteed. If the error rate is too high for the FEC used on a particular multimedia stream layer, the BTS may choose to only transmit the layers that most effectively can be used and the mobile stations will only turn on their radios long enough to capture the bits associated for the layers they can use. This saves mobile station battery life and decoding processing power. The BTS can also reduce the amount of time needed to transmit the multimedia by only transmitting the layers which employ sufficient FEC to be received, demodulated and decoded by the mobiles. This saves system bandwidth since valuable bits are not used for multimedia data layers that would be too damaged by channel errors to be useful. An important aspect to keep in mind, is that the decision to transmit a layer can be overruled by either the BTS or by user preferences or by mobile station limitations, in accordance with the disclosure of the assignee=s co-pending U.S. patent application Ser. No. (020392), incorporated herein by reference.

In another aspect, a method for transmission of multimedia data that is characterized by a base layer and at least one enhancement layer includes receiving, from at least one mobile station via a reverse access channel, a paging channel, an overhead channel, or other channel, information representing at least one actual operational parameter associated with the multimedia data. The method also includes dynamically establishing an error correction rate of at least one layer of the multimedia data based at least in part on the information representing at least one actual operational parameter.

Preferably, the actual operational parameter may be an actual error rate, or a channel condition, or a mobile station location, or mobile station limitations, user priority, content priority, and billing plans. The act of dynamically establishing may include establishing a base error rate for the base layer and an enhancement error rate for the enhancement layer, with the base and enhancement error rates not being constrained to be equal.

If the information from the mobile station indicates that the actual operational parameter is at least equal to a threshold, the error correction rate of at least one layer may be made more robust, depending on available bandwidth, and/or a mobile station request for higher quality of service. The actual operational parameter may be associated with the layer for which the error correction rate is made more robust.

Also, if the information indicates that the actual operational parameter is at least equal to a threshold, the layer associated with the parameter may be eliminated from transmission. Or, if the information indicates that the actual operational parameter is at least equal to a threshold, the mobile station may be signalled to ignore the layer associated with the parameter. However, overhead messages or other signaling could provide the information that some phones, which are currently part of a multicast group, could use to decide which layers to decode.

In another aspect, a base station for wirelessly transmitting digital multimedia to a wireless mobile station includes means for establishing a first error correction rate for a first layer of the multimedia, and means for establishing a second error correction rate for a second layer of the multimedia.

The details of the present invention, both as to its structure and operation, can best be understood in reference to the accompanying drawings, in which like reference numerals refer to like parts, and in which:

### BRIEF DESCRIPTION OF THE DRAWINGS

FIG. 1 is a block diagram of the present architecture;

FIG. 2 is a block diagram of an exemplary non-limiting base station (BTS); and

FIG. 3 is a flow chart of the present logic.

### DETAILED DESCRIPTION OF THE PREFERRED EMBODIMENT

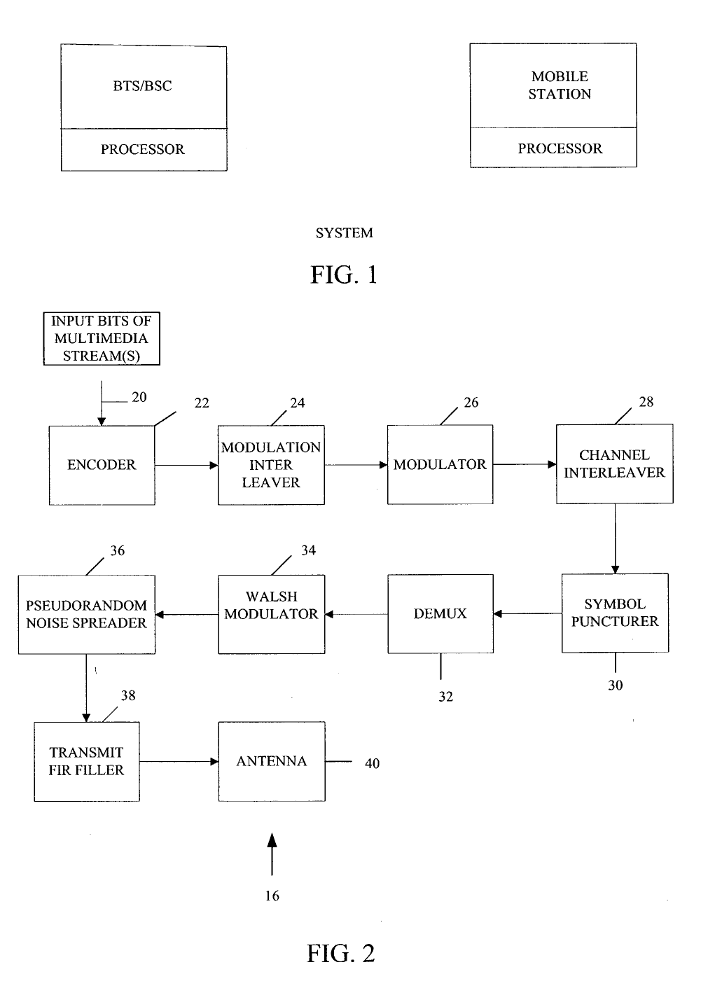

Referring initially to the non-limiting preferred embodiment shown in FIG. 1, a system 10 includes at least one mobile station 12 having at least one processor 14 and at least one base station (BTS) 16 transmitting digital multimedia streams and having a processor 18. In some implementations the BTS 16 may be a combined BTS and base station controller (BSC).

The preferred non-limiting BTS 16 uses wireless means, and more particularly uses code division multiple access (CDMA) principles. The streams can be broadcast or multicast to plural mobile stations 12 if desired, or transmitted using point-to-point wireless transmission principles, or multicast to groups of users. It is to be understood that the present principles apply to other forms of wireless communication such as GSM, TDMA, wideband CDMA, OFDM, etc. as well as transmission of multimedia over cable systems, the Internet, etc. As used herein in the singular, “multimedia stream” means a single stream representing a single program, e.g., a single music piece or a single television show or movie potentially with accompanying text, images, etc.

In one non-limiting preferred implementation the system 10 is a code division multiple access (CDMA) system that, e.g., uses cdma2000, cdma2000 3×, or cdma2000 high data rate (HDR) principles, or other CDMA principles. In one non-limiting embodiment the mobile station 12 is a mobile telephone made by Kyocera, Samsung, or other manufacturer that uses Code Division Multiple Access (CDMA) principles and CDMA over-the-air (OTA) communication air interfaces. The present invention, however, applies to other mobile stations such as laptop computers, wireless handsets or telephones, data transceivers, or paging and position determination receivers. The mobile station 12 can be hand-held or portable as in vehicle-mounted (including cars, trucks, boats, planes, trains), as desired. However, while wireless communication devices are generally viewed as being mobile, it is to be understood that the present invention can be applied to “fixed” units in some implementations. Also, the present invention applies to data modules or modems used to transfer voice and/or data information including digitized video information, and may communicate with other devices using wired or wireless links. Further, commands might be used to cause modems or modules to work in a predetermined coordinated or associated manner to transfer information over multiple communication channels. One example could be to transfer different layers over different channels including different physical layers of different communication systems, as set forth in the present assignee=s co-pending U.S. patent application Ser. Nos. (020726, 020727), incorporated herein by reference. Wireless communication devices are also sometimes referred to as user terminals, mobile stations, mobile units, subscriber units, mobile radios or radiotelephones, wireless units, or simply as “users” and “mobiles” in some communication systems. It is to be understood that the present invention applies equally to other types of wireless devices including without limitation GSM devices, time division multiple access (TDMA) systems, OFDM (802.11), etc.

Now referring to FIG. 2, input bits 20 contain the information representing layered multimedia streams. Each multimedia stream may include a base layer providing a minimum quality of service (QoS) and one or more enhancement layers providing heightened QoS.

The bits 20 are sent to an encoder 22. The encoder 22 can be a Forward Error Correction (FEC) encoder that introduces redundancy in the bits 20 using convolutional coding techniques known in the art. To do this, the preferred encoder 22 may establish, under the control of the BTS processor 18, an error correction rate that essentially generates more redundancy for greater robustness at the cost of requiring increased bandwidth to support the larger number of bits, or that generates less redundancy to conserve bandwidth at the cost of risking more uncorrectable errors at the receivers. Thus, the redundancy introduced by the encoder 22 enables the mobile stations 12 to correct some detection errors without the need to increase transmission power.

The output of the encoder 22 is generally referred to as “code symbols.” Generally, a single message data bit 20 input to the encoder 22 corresponds to one or more code symbols output from the encoder 22. In an alternative approach, the encoder 22 performs a “source encoding” function prior to the redundancy encoding discussed above. Source encoding involves performing data compression for efficient representation of input data bits 20 prior to introducing redundancy and the generation of code symbols.

A modulation interleaver 24 receives code symbols from the encoder 22 and “interleaves” the code symbols prior to processing by a modulator 26. In the exemplary system shown, the interleaver 24 may be a block interleaver or a convolutional interleaver.

The interleaved code symbols are passed on to the modulator 26. In wireless digital communications, a number of different, but related, modulation schemes can be used in the modulator 26. For example, Binary Phase Shift Keying (BPSK), Differential Phase Shift Keying (DPSK), Quadrature Phase Shift Keying (QPSK) (including OQPSK and n/4QPSK), and Quadrature Amplitude Modulation (QAM), are digital modulation techniques which can be used in the modulator 26 to modulate the code symbols generated by the modulation interleaver 24.

However, the modulator 26 is not limited to any specific tune of modulator and can be any of the many digital modulators used in wireless communications. The invention can also be applied to wired systems.

As shown in FIG. 2, the modulator 26 passes the modulated signals to a channel interleaver 28, which modifies the time order of the signals to be transmitted across the channel. The channel interleaver 28 may be a block interleaver or a convolutional interleaver or a turbo interleaver.

If desired, the channel interleaved symbols from the interleaver 28 may be passed on to a symbol puncture element 30, which can insert control information, such as power control information, in the data for proper handling of the communications between the transmitter and the receiver. The control symbols punctured into the message symbols are time division multiplexed into the message symbols, as disclosed in the assignee=s co-pending U.S. patent application Ser. No. (030237), incorporated herein by reference.

If desired, the symbol stream output by the symbol puncture element 30 can be sent to a demultiplexer (DEMUX) 32, which can be used for demultiplexing the input symbol stream into a number of parallel output symbol streams. In the exemplary BTS 16 shown in FIG. 2, the DEMUX 32 may be a one-to-sixteen demultiplexer.

From the DEMUX 32, the streams are sent to a Walsh function modulator 34 (that can include a Walsh function matrix of, e.g., order 16). In other embodiments, a Walsh function matrix of order 64 or 128 may be used. It is noted that, in the exemplary system 10, the parallel outputs of the DEMUX 32 can correspond to a single user or multimedia layer or program, or plural different users/streams/layers. In any case, Walsh modulation is performed on each of the parallel input symbols coming from the DEMUX 32, which is used to transform each input symbol into a respective sequence of output signals where each sequence of output signals is orthogonal with every other sequence of output signals.

As shown in FIG. 2, a Pseudorandom Noise (PN) spreader 36 may be provided to “spread” the signal in accordance with principles known in the art. The general principles of CDMA communication systems, and in particular the general principles for generation of spread spectrum signals for transmission over a communication channel is described in U.S. Pat. No. 4,901,307 entitled “Spread Spectrum Multiple Access Communication System Using Satellite or Terrestrial Repeaters” and assigned to the assignee of the present invention. The disclosure in that patent, i.e. U.S. Pat. No. 4,901,307, is hereby fully incorporated by reference into the present application. Moreover U.S. Pat. No. 5,103,459 entitled “System and Method for Generating Signal Waveforms in a CDMA Cellular Telephone System” and assigned to the assignee of the present invention, discloses principles related to PN spreading, Walsh covering, and techniques to generate CDMA spread spectrum communication signals. The disclosure in that patent, i.e. U.S. Pat. No. 5,103,459, is also hereby fully incorporated by reference into the present application. Further, the present invention utilizes time multiplexing of data and various principles related to “high data rate” communication systems, and the present invention can be used in a “high data rate” communication systems, disclosed in U.S. patent application entitled “Method and Apparatus for High Rate Packet Data Transmission” Ser. No. 08/963,386 filed on Nov. 3, 1997, and assigned to the assignee of the present invention. The disclosure in that patent application is also hereby fully incorporated by reference into the present application.

From the PN spreader 36 the signal maybe sent to a finite impulse response (FIR) filter 38, which may be a FIR filter used for pulse shaping signals prior to their transmission over a communication channel. The output of the transmit FIR filter 38 is sent through a BTS antenna 40 across the communication channel to the mobile stations. The communication channel usually refers to the physical medium which is used to send the signals from the transmitter to the receiver.

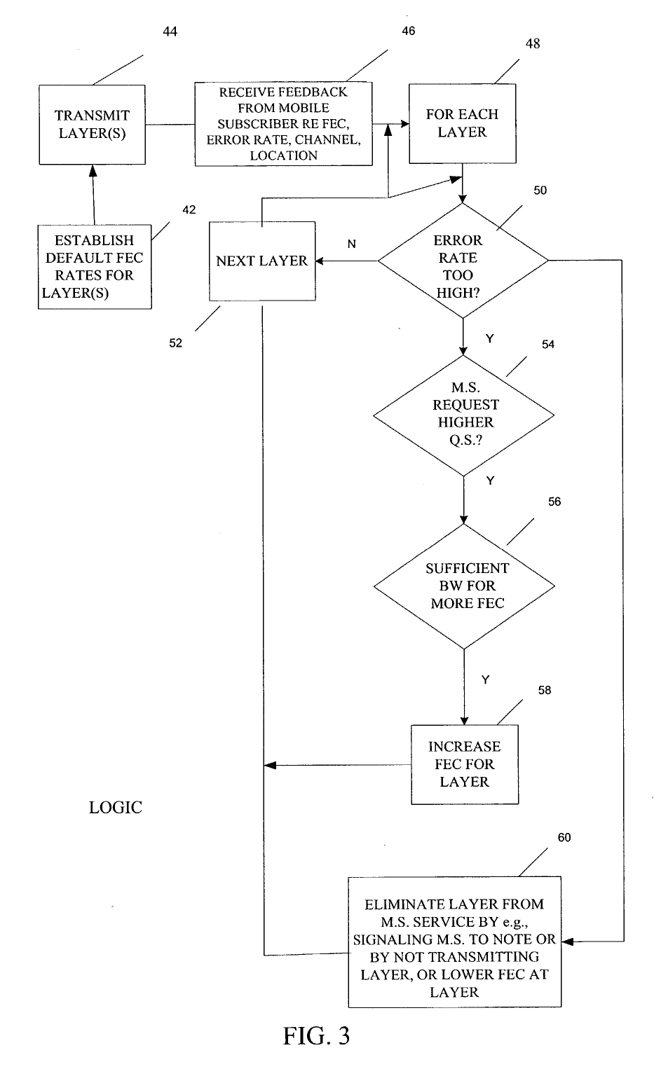

Now referring to FIG. 3, an exemplary non-limiting implementation of the present logic is shown, it being understood that the logic could be depicted in other ways. In essence, the logic is executed by the BTS processor 18 to select which layers of multimedia streams to transmit based on channel conditions, and/or mobile station location, and/or the forward error correction (FEC) used for a particular layer, and/or others like user preferences, mobile device capabilities etc. Also, in multicasting applications, the determination can be based on location and number of users in the multicast group. The time that a mobile station 12 receiver is on during transmission and reception of multimedia signals can thus be minimized to reduce power consumption and control bandwidth consumption in the cellular system in accordance with assignee=s co-pending U.S. patent applications Ser. Nos. 020293 and 030072, incorporated herein by reference. The BTS 16 can employ different FEC rates and/or different power levels for the various layers upon request from the mobile stations, depending on available bandwidth and current channel usage and priorities, in accordance with assignee=s co-pending U.S. patent applications Ser. Nos. 020590 and 020591, incorporated herein by reference.

With the above general description of the logic of the BTS 16 in mind, commencing at block 42 of FIG. 3, a default FEC rate and/or power can be established for each layer. Proceeding to block 44, the layers are wirelessly transmitted by the BTS 16 and received by one or more mobile stations 12. It is to be understood that power may be adjusted as FEC rate is adjusted to achieve a constant error parameter.

Moving to block 46, feedback is sent from the mobile station 12 (by, e.g., a reverse access channel, a paging channel, an overhead channel, or other channel) to the BTS 16. The feedback represents one or more actual operational parameters associated with the multimedia data, such as channel conditions as might be indicated by, e.g., interference, actual data error rates being experienced, multipath interference, power levels, etc. The feedback can also indicate actual or desired FEC rate in the received data, as well as information relating to the position of the mobile station 12.

Based on this feedback, the BTS 16 can ascertain which multimedia layers to transmit, and/or the most appropriate FEC rate for each layer. One non-limiting exemplary way to do this commences at block 48, wherein for each multimedia layer the logic proceeds to decision diamond 50 to determine whether the actual error rate at the mobile station 12 is too high. Equivalently, it can be determined whether the distance between the BTS 16 and MS 12 exceeds a threshold, or whether the channel conditions have degraded below a threshold. The thresholds can be empirically determined. Alternatively, the encoder can build a table which relates error conditions to layer usability.

If the actual error rate for the layer under test as reported by the MS 12 is not too high, the logic retrieves the next layer at block 52 and loops back to decision diamond 50. On the other hand, if the error rate meets or exceeds the threshold, the logic may flow to decision diamond 54 to determine whether the MS 12 has requested a higher QoS as might be reflected in, e.g., a more robust FEC rate for encoding the multimedia data. If so, in a preferred non-limiting embodiment the logic may further flow to decision diamond 56 to determine whether sufficient bandwidth exists to support an increased error correction implementation in terms of robustness (technically, a reduced FEC rate). If so, the FEC for the layer under test is increased in robustness (by, e.g., reducing the FEC rate) at block 58.

If either test at decision diamond 54, 56 is negative, the logic may proceed to block 60 At block 60, the BTS 16 may elect to eliminate the layer under test from transmission. Or, the BTS 16 may elect to signal to particular mobile stations 12 that have reported high actual error rates for the layer under test not to energize their radios for the periods in which data for the layer under test is transmitted. Or again, the BTS 16 may elect to lower the FEC encoding so that less error correction is realized, but bandwidth is conserved. From blocks 58 and 60 the logic loops back to block 52. Accordingly, a base error rate may be dynamically established for the base layer and an enhancement error rate may be dynamically established for the enhancement layer, with the base and enhancement error rates not being constrained to be equal. Periodically, the logic may recommence at block 42.

As mentioned above, instead of establishing FEC rate layer by layer, the principles advanced herein can be used to establish a power for each layer that is transmitted. This invention results in power savings on the mobile device, reduced over-the-air (OTA) RF radio power consumption, reduced OTA receiver demodulator power, OTS receiver decode power, and multimedia application decode savings. In addition, the BTS has increased control over bandwidth allocation to users and multicast groups as well as overall savings of system bandwidth and/or system spectrum.

While the particular BASE STATION-CENTRIC METHOD FOR MANAGING BANDWIDTH AND QoS IN ERROR-PRONE SYSTEM as herein shown and described in detail is fully capable of attaining the above-described objects of the invention, it is to be understood that it is the presently preferred embodiment of the present invention and is thus representative of the subject matter which is broadly contemplated by the present invention, that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more”. All structural and functional equivalents to the elements of the above-described preferred embodiment that are known or later come to be known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. Section 112, sixth paragraph, unless the element is expressly recited using the phrase “means for” or, in the case of a method claim, the element is recited as a “step” instead of an “act”.

What is claimed is:

1. A wireless transmission system for multimedia information having plural layers, comprising:
at least one base station (BTS) undertaking at least one of:
selecting which layers to transmit based on at least one of: channel conditions, mobile location, mobile station limitations, user priority, content priority, billing plans, available bandwidth, and forward error correction (FEC) used for a particular layer; and
dynamically establishing at least one of: a respective FEC rate, and a respective power, for each layer upon request from at least one mobile station dependent on at least one of: available bandwidth, and current channel usage and/or priorities, user preferences, mobile station capabilities, user billing plans.

2. The system of claim 1, wherein if an actual error rate at least equals a threshold for a particular layer, the BTS transmits only layers other than the particular layer such that mobile stations energize their radios only to capture layers they can use, thereby conserving mobile station battery life and decoding processing power.

3. The system of claim 2, wherein the BTS transmits only layers which employ sufficient FEC to be received, demodulated and decoded by mobile stations, such that bandwidth is conserved in that valuable bits are not used for multimedia data layers that would be too damaged by channel errors to be useful.

4. A method for transmission of multimedia data characterized by at least a base layer and at least one enhancement layer, comprising:
receiving, from at least one mobile station, information representing at least one actual operational parameter associated with the multimedia data; and
dynamically establishing at least one of: an error correction rate, and a power level, of at least one layer of the multimedia data based at least in part on the information representing at least one actual operational parameter.

5. The method of claim 4, wherein the actual operational parameter is an error rate.

6. The method of claim 4, wherein the actual operational parameter represents at least one of: channel conditions, mobile location, mobile station limitations, user priority, content priority, billing plans, and forward error correction (FEC) used for a particular layer.

7. The method of claim 4, wherein the receiving and establishing acts are undertaken at a base station of a wireless communication network.

8. The method of claim 4, wherein the mobile station is wireless.

9. The method of claim 4, wherein the act of dynamically establishing includes establishing a base error rate for the base layer and an enhancement error rate for the enhancement layer, the base and enhancement error rates not being constrained to be equal.

10. The method of claim 4, wherein if the information indicates that the actual operational parameter is at least equal to a threshold, the error correction rate of at least one layer is made more robust.

11. The method of claim 10, wherein the error correction rate of at least one layer is made more robust depending on at least one of: channel conditions, mobile location, mobile station limitations, user priority, content priority, billing plans, available bandwidth, and forward error correction (FEC) used for a particular layer

12. The method of claim 10, wherein the actual operational parameter is associated with the at least one layer having the error correction rate being made more robust.

13. The method of claim 4, wherein if the information indicates that the actual operational parameter is at least equal to a threshold, the layer associated with the parameter is eliminated from transmission.

14. The method of claim 4, wherein if the information indicates that the actual operational parameter is at least equal to a threshold, the layer associated with the parameter is selectively eliminated from transmission.

15. The method of claim 4, wherein if the information indicates that the actual operational parameter is at least equal to a threshold, at least one mobile station is signalled to ignore the layer associated with the parameter.

16. The method of claim 4, wherein if the information indicates that the actual operational parameter is at least equal to a threshold, at least one mobile station is selectively signalled to ignore the layer associated with the parameter.

17. A base station for wirelessly transmitting digital multimedia to at least one wireless mobile station, comprising:
means for establishing at least one of: a first error correction rate, and a first power, for a first layer of the multimedia; and
means for establishing at least one of: a second error correction rate, and a second power, for a second layer of the multimedia.

18. The base station of claim 17, wherein the means for establishing operate dynamically.

19. The base station of claim 17, further comprising means for receiving, from at least one mobile station, information representing at least one actual operational parameter associated with the multimedia data.

20. The base station of claim 19, wherein the actual operational parameter is at least one of: an error rate, at least one channel condition, and at least one mobile station location.

21. The base station of claim 19, wherein if the information indicates that the actual operational parameter is at least equal to a threshold, the error correction rate of at least one layer is made more robust.

22. The base station of claim 19, wherein the error correction rate of at least one layer is made more robust depending on at least one of: available bandwidth, and mobile station request for higher quality of service.

23. The base station of claim 19, wherein if the information indicates that the actual operational parameter is at least equal to a threshold, the layer associated with the parameter is eliminated from transmission.

24. The base station of claim 19, wherein if the information indicates that the actual operational parameter is at least equal to a threshold, the mobile station is signaled to ignore the layer associated with the parameter.
